(19) United States
(12) Patent Application Publication
(10) Pub. No.: US 2008/0261019 A1
(43) Pub. Date: Oct. 23, 2008

(54) Pvc/Wood Composite

(75) Inventors: Xianfeng Shen, King of Prussia, PA (US); Thomas Bole, Westlake, OH (US); Robert A. Iezzi, West Chester, PA (US); Zuzanna Cygan, Blue Bell, PA (US); Rong M. Hu, Norristown, PA (US); Barbara L. Stainbrook, Lawrenceville, PA (US); Peter A. Callais, Conroe, TX (US); Jason S. Ness, East Norriton, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA INC., PHILADELPHIA, PA (US)

(21) Appl. No.: 12/091,371

(22) PCT Filed: Oct. 13, 2006
(86) PCT No.: PCT/US06/40133

§ 371 Date: Jun. 19, 2008

Related U.S. Application Data
(60) Provisional application No. 60/729,649, filed on Oct. 24, 2005.
(60) Provisional application No. 60/816,508, filed on Jun. 26, 2006.

(51) Int. Cl. B32B 5/14; B32B 23/14

(52) U.S. Cl. 428/317.5; 428/532; 428/507; 428/424.6; 428/537.1; 428/537.5; 428/402

(57) ABSTRACT

The present invention relates to a thermoplastic/natural cellulosic fiber composite, and more specifically to a high molecular weight compatibilizer within that composite resulting in both a high flex strength and high modulus and significant reduction in water absorption. The compatibilizer is preferably a terpolymer comprising: a) 0.5-20 percent by weight of monomer units selected from the group consisting of maleic anhydride, substituted maleic anhydride, mono-ester of maleic anhydride, itaconic anhydride, maleic acid, fumaric acid, crotonic acid, acrylic acid and methacrylic acid; b) 0 to 40 percent by weight of monomer units selected from styrene and functionalized styrene; and c) 40 to 98.5 percent by weight of monomer units selected from the group consisting of C₁₋₈ alkyl acrylates and methacrylates, and vinyl acetate.

### FIELD OF THE INVENTION

The present invention relates to a thermoplastic/natural cellulosic fiber composite, and more specifically to a high molecular weight compatibilizer within said composite resulting in both a high flexural strength and high modulus and significant reduction in water absorption.

### BACKGROUND OF THE INVENTION

Natural and wood fiber plastic composites (WPCs) for decking and railing represent a very large market which is seeing significant growth. The majority of the WPC market is currently wood-polyolefin composites (PE and PP). However, there is movement toward wood-PVC for the following reasons: (a) virgin PVC is now less costly; and (b) PVC has advantages over polyolefins because it is less flammable, can be foamed easier, and has better inherent mechanical properties.

Despite the rapidly growing use of WPCs, there are technical challenges to overcome for continued market growth. Wood fibers are polar (hydrophilic) whereas most polymers, especially thermoplastics, are non-polar (hydrophobic). This incompatibility can result in poor adhesion between polymer and wood fibers in WPCs. As a result, the mechanical properties, water resistance, and other properties are compromised. A good compatibilized system is needed to thoroughly disperse wood fibers into the polymer during extrusion to avoid poor melt strength of the wood composite extrudates. Poor melt strength leads to melt fracture on the surface of the extrudates.

Modifications to the wood fiber, and the use of compatibilizers, coupling agents, and interfacial agents have been used to improve the compatibility and adhesion between the wood and plastic in the WPCs. U.S. Pat. No. 3,894,975 and 3958069 describe an in-situ polymerization of wood fibers with maleic anhydride and styrene to prepare a wood-polymer composite. U.S. Pat. No. 4,851,458 describes a pretreatment of cellulose fibers with an adhesion promoter. Other additives for improving the compatibility and adhesion of wood and plastic include: isocyanate bonding agents (U.S. Pat. No. 4,376,144 and GB 2192398); silane bonding agents (U.S. Pat. No. 4,820,749 and GB 2192397).

US 2004/0204519 describes the use of low molecular weight chlorinated waxes as coupling agents. U.S. Pat. No. 5,858,522 describes interfacial agents of low molecular weight polymers, copolymers and terpolymers including poly(methyl methacrylate-co-methacrylic acid), poly(vinyl chloride-co-vinyl acetate-co-maleic anhydride), and polystyrene-b-polyacrylic acid. These low molecular weight materials act as surfactants for the wood, but lack the advantages of high molecular weight polymers in the improvement of physical properties.

WPC composites having low levels (10-45%) of chemically modified cellulosic fiber have also been described (U.S. Pat. No. 6,210,792 and U.S. Pat. No. 5,981,067). Manufacturers are moving to composites having higher levels of cellulosic fillers, requiring new additives designed to compatibilize the large amount of cellulosic fillers into a polymeric matrix. Advantages of using a compatibilizer containing a carboxylic acid or anhydride are described in JP 199140260. The level of maleic anhydride in each of the examples is very high (30-50%). This high level of maleic anhydride creates process problems, such as cross-linking, discoloration, higher viscosity, and lower output in the manufacture of the WPC.

Although coupling agents increase the flexural strength of the WPC products, most manufacturers in WPC industry do not use coupling agents, compatibilizers, or interfacial agents because they do not improve the flexural modulus of composites. As the industry moves to higher levels of cellulosic fiber, there is a need for an additive that improves both the flexural strength and the modulus of a wood-polymer composite.

Surprisingly it was found that both flexural strength and modulus of a wood/thermoplastic composite improves significantly using high molecular weight compatibilizers consisting of specific polar and non-polar monomers in random, gradient and block co- and ter-polymers. A preferred terpolymer of polystyrene, maleic anhydride, and methyl methacrylate provided excellent properties in a wood/PVC composite.

Additionally it was found that the use of the compatibilizer of the invention results in reduced water absorption in both hardwood (oak) and softwood (pine) systems.

### SUMMARY OF THE INVENTION

The invention relates to a composite material comprising a homogeneous distribution comprising:

20-60 weight percent of one or more thermoplastic;
a) 40-80 weight percent of natural cellulosic fibers; and
b) 0.5 to 15 weight percent of a polymeric compatibilizing agent—based on the weight of the cellulosic fiber, having a weight average molecular weight greater than 10,000 and having a hydrophilic moiety and a hydrophobic moiety.

The invention further relates to a process for reducing the fusion time in the processing of a thermoplastic comprising adding to said thermoplastic prior to or during processing a fusion control agent comprising a terpolymer comprising:
a) 0.5-20 percent by weight of monomer units selected from the group consisting of ethylenically unsaturated carboxylic acids, ethylenically unsaturated carboxylic acid anhydrides, and derivatives thereof;
b) 1 to 40 percent by weight of monomer units selected from styrene and functionalized styrene; and
c) 40 to 98.5 percent by weight of monomer units selected from the group consisting of C₁₋₈ alkyl acrylates and methacrylates, and vinyl acetate.

### DETAILED DESCRIPTION OF THE INVENTION

The invention relates to composite of a thermoplastic and natural cellulosic fibers with a polymeric compatibilizer having hydrophilic and hydrophobic moieties. Specifically, the compatibilizer is a high molecular weight polymer containing as the hydrophilic moiety a (di)carboxylic acid or dicarboxylic acid anhydride.

The hydrophilic moiety of the polymeric compatibilizer of the invention can be any hydrophilic moiety either in the polymer backbone, or grafted onto the polymer backbone. While not being bound by any particular theory, it is believed that the hydrophilic moiety of the polymeric compatibilizer will either a) react with the cellulosic hydroxyl groups through esterification; b) form hydrogen bonds with the cellulosic hydroxyl groups; and/or c) form crosslinks between the thermoplastic and the surface of the cellulose.

Preferred hydrophilic moieties are functional groups that are capable of forming covalent bonds with hydroxyl groups. More preferably, the hydrophilic moiety is an ethylenically unsaturated carboxylic acid, ethylenically unsaturated carboxylic acid anhydride, or derivatives of the foregoing. Most preferably the hydrophilic moiety is an alpha-beta unsaturated carbonyl. Examples of (di)carboxylic acids and anhydride moieties and their derivatives useful in the compatibilizer of the invention include, but are not limited to maleic anhydride, maleic acid, substituted maleic anhydride, mono-ester of maleic anhydride, itaconic anhydride, itaconic acid, substituted itaconic anhydride, mono ester of itaconic acid, fumaric acid, fumaric anhydride, fumaric acid, substituted fumaric anhydride, monoester of fumaric acid, crotonic acid and its derivatives, acrylic acid, and methacrylic acid. While not being bound by any theory, it is believed that the anhydride groups react faster with the hydroxyls on the wood fibers than the acid groups, and therefore are a more preferred hydrophilic moiety.

The hydrophilic moiety comprises 0.5 to 20 weight percent, and more preferably from 8 to 12 percent by weight of the polymeric compatibilizer. The hydrophilic moiety may be a monomer polymerized into the polymeric backbone, or added to the polymeric backbone after polymerization, such as through grafting. Preferably the hydrophilic moiety consists of a hydrophilic monomer copolymerized into the polymeric backbone.

The hydrophobic moiety should be highly compatible with the thermoplastic used in the WPC. In the case of a polyolefinic thermoplastic, the preferred hydrophobic moieties include, but are not limited to HDPE, LDPE, LLDPE, and PP. For a polyvinyl chloride (PVC) thermoplastic, the preferred hydrophobic moieties include, but are not limited to C₁₋₈ alkyl acrylates and methacrylates, vinyl acetate, and chlorinated polyethylene. Preferably the hydrophobic moiety for use in a PVC-WPC is methyl methacrylate or vinyl acetate.

The polymeric compatibilizer of the invention contains two or more monomeric species, and may be a copolymer, a terpolymer, or contain more than three monomeric species. In one preferred embodiment, a terpolymer of maleic anhydride, styrene, and methyl methacrylate is used as the compatibilizer. The maleic anhydride is used as the hydrophilic moiety, the styrene monomer is used to facilitate the polymerization of the maleic anhydride and also for its lubricant effect in PVC, and the methyl methacrylate is used as the hydrophobic moiety. Alternatively, the maleic anhydride can be partially reacted as a partial ester; the styrene could be a functionalized styrene, such as alpha methyl styrene; and the maleic anhydride could be a dicarboxylic acid or anhydride. The maleic anhydride is present at from 0.5 to 20, preferably 5-15 and more preferably from 8-12 weight percent; the styrene is present at a level about twice that of the maleic anhydride, or from 1 to 40, preferably 10-30, and more preferably 16-24 weight percent; and the methyl methacrylate present at from 40 to 98.5, preferably 55-85 and more preferably from 64 to 76 weight percent of the compatibilizer.

In one preferred embodiment, the polymeric compatibilizing agent is a copolymer of from 50 to 99.5 weight percent, and preferably 80 to 98 weight percent of methyl methacrylate and 0.5 to 50 weight percent, preferably 2 to 20 weight percent methacrylic acid, and from 0 to 20 weight percent of styrene.

The molecular weight of the polymeric compatibilizer is from 10,000 to 250,000, and preferably 25,000 to 150,000 when made by solution polymerization, bulk polymerization, emulsion polymerization, or suspension polymerization. The molecular weight could go up to 1,000,000 if the polymer synthesis is by emulsion polymerization. Generally solution polymerization or bulk polymerization is used for polymerization of the preferred anhydride monomers. While not being bound by any particular theory, it is believed that the higher molecular weight polymeric compatibilizer of the invention forms stronger interactions with the thermoplastic matrix and cellulosic fibers due to entanglements and physical interactions in addition to the chemical interactions. It is also believed that a very low molecular weight polymeric compatibilizer has less entanglements with the thermoplastic matrix, whereas a polymeric compatibilizer with too high of a molecular weight leads to poor mixing due to the increased viscosity.

The polymeric compatibilizer of the invention may have any polymer architecture, including random, gradient, or block.

Block polymers may be made using controlled radical polymerization methods known in the art. Both di- and tri-block polymers work as compatibilizers of the invention. In one embodiment a bis-alkoxyamine initiator is used to obtain a triblock structure, with a nitroxide to control the reaction kinetics. In a block polymer, the styrene and maleic anhydride are polymerized to form a polymeric macroinitiator (B), and the methylmethacrylate (A) is then added to form an A-B-A triblock copolymer.

Gradient compatibilizers may be synthesized in a one-pot fashion without separating the macroinitiators as for block copolymer synthesis. In one embodiment a controlled radical polymer technique is used to form a styrene-co-maleic anhydride copolymer, and prior to full conversion a methylmethacrylate monomer stream is started. In addition to the ease of preparation, gradient copolymers offer similar structural types to block copolymers.

Random polymeric compatibilizers of the invention may be synthesized by radical polymerization methods known in the art. The polymerization may be bulk, or continuous in which a portion of the monomers and initiator are added to the reactor initially, and the remainder are added slowly over a period of time. The polymerization may also be a suspension or emulsion polymerization. The high molecular weight compatibilizer may be used in a solvent as polymerized, or may be dried by means known in the art and made available as a powder, or a pellet.

The thermoplastic matrix can be any thermoplastic including, but not limited to polyvinyl chloride, chlorinated polyvinyl chloride, chlorinated polyethylene, high density polyethylene, low density polyethylene, polypropylene, other olefin resins, polystyrene, acrylonitile/styrene copolymers, acrylonitrile/butadiene/styrene copoloymers, ethylene/vinyl acetate copolymers, polymethyl methacrylate, and vinyl chloride copolymers. Preferably the thermoplastic matrix is made up of olefinic polymers, polyvinyl chloride (PVC) or chlorinated polyvinyl chloride (CPVC). Most preferably the thermoplastic is polyvinyl chloride or chlorinated polyvinyl chloride. The thermoplastic matrix comprises less than 50 percent by weight of the WPC. PVC or CPVC has advantages such as being better able to accept a capstock, and being able to be easily foamed to form a lighter and less expensive WPC.

While a WPC is generally referred to as a wood-polymer composite, it is envisioned that any cellulosic material, either natural or regenerated, may be used as the fibrous filler of the present WPCs. The cellulosic material may be a mixture of one or more materials including, but not limited to wood flour, wood fiber, and agricultural fibers such as wheat straw, flax, hemp, kenaf, nut shells, and rice hulls. The cellulosic material may also be a pulped cellulosic fiber. The pulped cellulosic fiber may be made of fully or partially recycled materials, such as, for example, pulped cellulosic fibers from CREAFILL. Typical cellulosic fibers contain 8%-12% moisture, therefore reducing the moisture content is needed either by pre-drying the fibers or other methods known in the art. The cellulosic fiber is present in the composite at from 40 to 80 percent by weight, preferably from 45 to 80 percent by weight, more preferably greater than 50 percent by weight, and most preferably from 55 to 70 percent by weight of the composite. Wood polymer composites containing pulped cellulosic fiber may contain 10 to 90 weight percent of the thermoplastic and 10-90 weight percent of pulped cellulosic fiber.

Typically the polymeric compatibilizer is present in the WPC at from 0.5-15, preferably 1-10, and more preferably at from 1.5-7.5 weight percent, based on the weight of the wood fiber.

The wood polymer composite is formed by blending the thermoplastic, cellulosic fiber and polymeric compatibilizer, and other additives in any order and by any method, and then either directly forming the mixture into a final article, or else forming the mixture into a form useful for further processing, such as pellets or a powder. One additive of special note is the addition of antimicrobial additives. In one embodiment, the wood polymer composite is formed by blending the thermoplastic matrix and any additives, including the polymeric compatibilizer and typical additives such as lubricants, antioxidants, UV and heat stabilizers, colorants, impact modifiers, and process aids. The cellulosic (wood) fiber is then added prior to entering an extruder. The WPC may then be extruded directly into a final shaped article, or may be pelletized or ground to a powder prior to final use.

A WPC made of the composition of the invention can be formed into a final article by means known in the art, such as by extrusion or injection molding.

The WPC with compatibilizers described in the invention provides excellent flexural strength and modulus, and results in a decrease in moisture adsorption compared to the WPC control without compatibilizers. Additionally the WPC of the invention has a reduced coefficient of linear thermal expansion (CLTE or COE), improving the dimensional tolerances of a finished part. The WPC is useful in many applications, including, but not limited to outdoor decks, siding, fencing, roofing, industrial flooring, landscape timbers, railing, moldings, window and door profile, and automobile applications. The WPC may be foamed to produce a lighter and less expensive composite material.

In addition to being a compatibilizer for cellulosic fibers and thermoplastics, there is evidence to show that the compatibilizer of the invention may also act as a fusion control agent for thermoplastics, with or without the presence of cellulosic fiber.

### EXAMPLES

### Examples 1-8

### a) Synthesis of a Random Compatibilizer (PSt-r-MAH-r-MMA) Polymer I

A mixture containing 30 grams (0.306 mol) maleic anhydride, 60 grams (0.576 mol) styrene, 210 grams (2.10 mol) methyl methacrylate, 1.5 grams (9.13 mmol) azobisisobutyronitrile (AIBN), and 300 grams (3.30 mol) toluene was added to a stainless steel resin kettle under nitrogen (≈0 psi), and heated to 80° C. under vigorous stirring. The temperature was maintained for approximately 6 hours, at which point the reaction had reached 90% conversion as measured by gas chromatography (GC). The reaction mixture was then cooled to room temperature. The residual monomer and toluene was removed by vacuum drying. The Mw=70,100 g/mol, and Mn=34,600 g/mol was determined by SEC analysis as compared to polystyrene standards.

### b) Compounding with 60 wt % Wood Fibers (Pine and Oak)

Wood/polymer composites were compounded using the formulation:

| | Concentration (phr) | | | | | | | |
|---|---|---|---|---|---|---|---|---|
| | Ex 1 | | | | Ex 5 | | | |
| Ingredient | Comp. | Ex 2 | Ex 3 | Ex 4 | Comp. | Ex 6 | Ex 7 | Ex 8 |
| PVC (K-value = 66) | 100 | 100 | 100 | 100 | 100 | 100 | 100 | 100 |
| (Oxyvinyls) | | | | | | | | |
| Tin stabilizer | 2 | 2 | 2 | 2 | 2 | 2 | 2 | 2 |
| (Thermolite | | | | | | | | |
| 172) | | | | | | | | |
| Calcium | 1.5 | 1.5 | 1.5 | 1.5 | 1.5 | 1.5 | 1.5 | 1.5 |
| stearate | | | | | | | | |
| (Synpro) | | | | | | | | |
| Paraffin wax | 2 | 2 | 2 | 2 | 2 | 2 | 2 | 2 |
| (Gulf Wax) | | | | | | | | |
| Acrylic impact | 3 | 3 | 3 | 3 | 5 | 5 | 5 | 5 |
| modifier | | | | | | | | |
| (Durastrength | | | | | | | | |
| 510) | | | | | | | | |
| Processing aid | 1 | 1 | 1 | 1 | 2 | 2 | 2 | 2 |
| (Plastistrength | | | | | | | | |
| 770) | | | | | | | | |
| Pine wood flour | 165 | 165 | 165 | 165 | — | — | — | — |
| 40 mesh | | | | | | | | |
| Oak | — | — | — | — | 165 | 165 | 165 | 165 |
| wood flour 40 | | | | | | | | |
| mesh | | | | | | | | |
| Polymer I | 0 | 2.5 | 5.0 | 7.5 | 0 | 2.5 | 5.0 | 7.5 |
| compatibilizer | | | | | | | | |
| (wt % to | | | | | | | | |
| wood) | | | | | | | | |

### c) Processing and Testing

The ingredients were weighed and mixed in a 10-liter high intensity mixer (Papenmeier, TGAHK20) for 10 min at room temperature. The mixture was then fed into a 32 mm conical counter rotating twin-screw extruder (C. W. Brabender Instruments, Inc.) with a L/D ratio of 13:1, driven by a 7.5 hp Intelli-Torque Plasti-Corder Torque Rheometer. The barrel temperatures for the three zones inside the extruder were set at 190° C., 180° C., and 170° C. The die (rectangular die 1″ width by ⅜″ thickness) temperature was set at 170° C., and the rotational speed of the screws was held at 40 rpm. Extrudates were cooled by air and then cut into testing specimen (8″×1″×⅜″). Three-point flexural tests were performed on an Instron 4206 testing machine (using Series IX software). The ASTM standard D 6109 was used and the crosshead speed was 0.1776 in/min. Water absorption after 2 hrs boiling in water and the corresponding thickness swelling were determined in accordance with the ASTM D570.

Testing results are summarized in TABLE 1 below. MOR=Modulus of Rupture (a measure of flexural strength), MOE=Modulus of Elasticity (a measure of flexural modulus)

TABLE 1
Flexural Properties
60% Pine and Oak Wood Flour with PVC

| | | MOR | | MOE |
|---|---|---|---|---|
| Sample | MOR (MPa) | Change | MOE (MPa) | Change |
| 1 (comp.) | 19.71 ± 0.79 | / | 2315.95 ± 65.16 | / |
| 2 | 29.08 ± 1.19 | 48% | 3068.17 ± 81.84 | 32% |
| 3 | 31.14 ± 1.28 | 58% | 3231.57 ± 63.26 | 40% |
| 4 | 34.70 ± 1.46 | 76% | 3474.27 ± 98.74 | 50% |
| 5 (comp.) | 19.41 ± 0.99 | / | 1855.4 ± 104.66 | / |
| 6 | 29.71 ± 0.97 | 53% | 2871.3 ± 49.93 | 54% |
| 7 | 29.34 ± 1.95 | 51% | 2775.6 ± 88.71 | 49% |
| 8 | 32.74 ± 1.44 | 69% | 2806.1 ± 96.29 | 51% |

The results have shown that with the addition of Polymer I, both flexural strength (up to 76%) and modulus (up to 50%) have increased significantly compared to the control. Modulus improvement to such an extent is highly desired.

### Processing Data

We also recorded the processing output and torque value for this study. Process Ease (Output/Torque) was used to describe the easiness of processing with or without Polymer I as compatibilizer. In this case, we observed that the addition of Polymer I only slightly compromise the composite processing at 2.5 and 5% loading levels.

TABLE 2

| | | | | | Process |
|---|---|---|---|---|---|
| | MOR | | | | Ease |
| Sample | (MPa) | MOE (MPa) | Output (kg/hr) | Torque (Nm) | (Output/Torque) |
| 1 (comp) | 19.71 ± 0.79 | 2315.95 ± 65.16 | 1.39 ± 0.08 | 11.3 | 0.12 |
| 2 | 29.08 ± 1.19 | 3068.17 ± 81.84 | 1.15 ± 0.04 | 12.8 | 0.09 |
| 3 | 31.14 ± 1.28 | 3231.57 ± 63.26 | 0.99 ± 0.08 | 12.7 | 0.08 |
| 4 | 34.70 ± 1.46 | 3474.27 ± 98.74 | 1.50 ± 0.06 | 12.9 | 0.12 |

### Water Absorption and Thickness Swelling

Based on ASTM D570, water absorption after 2 hrs boiling in water and the corresponding thickness swelling were determined. Significant drop of weight gain and thickness swelling was observed even with only 2.5% Polymer I.

TABLE 3
60% Pine and Oak Wood Flour with PVC

| | Weight | Weight Gain | | Swell |
|---|---|---|---|---|
| Sample | Gain % | Change | Swell % | Change |
| 1 (comp) | 44 | / | 27 | / |
| 2 | 26 | 41% | 18 | 33% |
| 3 | 25 | 43% | 17 | 37% |
| 4 | 15 | 66% | 13 | 52% |
| 5 (comp) | 35 | / | 27 | / |
| 6 | 27 | 15% | 19 | 30% |
| 7 | 24 | 34% | 14 | 48% |
| 8 | 35 | 41% | 12 | 56% |

We have demonstrated in this series of study that our compatibilizer Polymer I significantly improves the flexural properties of the resulting composites and reduced the water absorption in both hardwood (oak) and softwood (pine) system.

### Example 9

### Fusion Control

A master Batch of the formulation below was formed and hand mixed into a WPC. The Brabender Fusion was measured at 65 g, 170° C. and 75 rpm.

| Master Batch | phr |
|---|---|
| PVC (K-66) | 100 |
| Stabilizer | 2.0 |
| CaSt | 1.5 |
| Parafin wax | 2.0 |
| Impact modifier | 3.0 |
| Process Aid | 1.0 |

Hand mix

| | 1 | 2 |
|---|---|---|
| Master Batch | 65 g | 60.5 g |
| WPC | 0 | 4.5 |

TABLE 4
Brabender Fusion (65 g, 170° C., 75 rpm)

| | Formulation | | | |
|---|---|---|---|---|
| | 1 | 2 | 1 | 2 |
| Fusion Time (min) | 3.00 | 1.14 | 3.00 | 1.06 |
| Fusion Touque (m-g) | 2368 | 2818 | 2365 | 2741 |
| Stock Temp (° C.) | 181 | 179 | 180 | 179 |

### Examples 10-12

### a) Synthesis of a random compatibilizer (PSt-r-MAA-r-MMA) Polymer II

A 5 liter glass reactor was charged with 40.54 g of sodium laurel sulfate and 2467.50 g of distilled water. The reactor was heated under nitrogen with vigorous stirring to a temperature of 80° C. A solution of 12 g of potassium persulfate and 388 g of distilled water was then added by batch. A monomer mixture consisting of 1080 g of methylmethacrylate, 60 g of styrene, 60 of methacrylic acid and 12 go fn-dodecylmercaptan was added at 20.2 g/min within 60 minutes. The reaction solution was stirred at 80° C. for 2 hours and then cooled and frozen at −20° C. for approximately 15 hours. The solution was then thawed and filtered. The polymer was collected and dried in an oven at 60° C. for approximately 20 hours. The Mw=58,700 g/mol, and Mn=27,300 g/mol was determined by SEC analysis as compared to polystyrene standards.

### b) Compounding with 60 wt % Wood Fibers (Pine and Oak)

Wood/polymer composites were compounded using the formulation:

| | Concentration (phr) | | |
|---|---|---|---|
| Ingredient | Ex 10 | Ex 11 | Ex 12 |
| PVC (K-value = 65) (Georgia | 100 | 100 | 100 |
| Gulf 5385) | | | |
| Tin stabilizer (Thermolite 172) | 1 | 1 | 1 |
| Calcium stearate (Synpro 15F) | 1.5 | 1.5 | 1.5 |
| Paraffin wax (Rheolub 165) | 1.2 | 1.2 | 1.2 |
| Oxidized PE wax (AC 629A) | 0.2 | 0.2 | 0.2 |
| Processing aid (Plastistrength | 3 | 3 | 3 |
| 530) | | | |
| Processing aid (Plastistrength | 1 | 1 | 1 |
| 770) | | | |
| Maple wood flour (40 mesh) | 132 | 132 | 132 |
| Oak wood flour (40 mesh) | 33 | 33 | 33 |
| Polymer II | 0 | 7.0 | 3.5 |
| Compatibilizer (wt % to wood) | | | |

### c) Processing and Testing

The ingredients were weighed and mixed in a 6-liter high intensity mixer (Henshel FM 10VS) for 5 min. The mixture was then fed into a 32 mm conical counter rotating twin-screw extruder (C. W. Brabender Instruments, Inc.) with a L/D ratio of 13:1, driven by a 7.5 hp Intelli-Torque Plasti-Corder Torque Rheometer. The barrel temperatures for the three zones inside the extruder were set at 193° C., 187° C., and 171° C. The die (rectangular die 2″ width by ⅛″ thickness) temperature was set at 171° C., and the rotational speed of the screws was held at 10 rpm. Extrudates were cooled by air and then cut into testing specimen (4″×½″×⅛″). Three-point flexural tests were performed on an Instron 4204 testing machine (using Series IX software). The ASTM standard D 790 was used and the crosshead speed was 0.0530 in/min.

Testing results are summarized in TABLE 4 below. MOR=Modulus of Rupture (a measure of flexural strength), MOE=Modulus of Elasticity (a measure of flexural modulus)

TABLE 4
Flexural Properties
60% Maple/Oak blend Wood Flour with PVC

| | | MOR | | MOE |
|---|---|---|---|---|
| Sample | MOR (psi) | Change | MOE (kpsi) | Change |
| 1 (comp.) | 6835 ± 77 | / | 812.9 ± 18.4 | / |
| 2 | 10715 ± 250 | 57% | 871.9 ± 2.2 | 7% |
| 3 | 9412 ± 319 | 38% | 887.1 ± 30.1 | 9% |

The results have shown that with the addition of Polymer II, both flexural strength (up to 57%) and modulus (up to 9%) have increased significantly compared to the control.

1. A composite material comprising a homogeneous distribution comprising:
a) 20-60 weight percent, of one or more thermoplastic;
b) 40-80 weight percent, preferably 45-80 weight percent, of cellulosic fibers; and
c) 0.5 to 15 weight percent of a polymeric compatibilizing agent—based on the weight of the cellulosic fiber, having a weight average molecular weight greater than 10,000, and having a hydrophilic moiety and a hydrophobic moiety.

2. (canceled)

3. The composite material of claim 1 comprising from 50 to 75 weight percent, of cellulosic fiber.

4. The composite material of claim 1, wherein said hydrophilic moiety is an ethylenically unsaturated carboxylic acid, ethylenically unsaturated carboxylic acid anhydride, and derivative of the foregoing.

5. The composite material of claim 1, wherein said hydrophilic moiety is an alpha-beta carbonyl.

6. The composite material of claim 1, wherein said hydrophilic moiety comprises 0.5 to 20 percent by weight of the polymeric compatibilizing agent.

7. The composite material of claim 1, wherein said hydrophobic moiety comprises C₁₋₈ alkyl acrylates, C₁₋₈ alkyl methacrylates, chlorinated ethylene, or vinyl acetate.

8. The composite material of claim 1, wherein said polymeric compatibilizing agent is a terpolymer comprising:
a) 0.5-20 percent by weight of monomer units selected from the group consisting of ethylenically unsaturated carboxylic acids, ethylenically unsaturated carboxylic acid anhydrides, and derivatives thereof;
b) 1 to 40 percent by weight of monomer units selected from styrene and functionalized styrene; and
c) 40 to 98.5 percent by weight of monomer units selected from the group consisting of C₁₋₈ alkyl acrylates and methacrylates, and vinyl acetate.

9. The composite material of claim 8 wherein said ethylenically unsaturated carboxylic acids, ethylenically unsaturated carboxylic acid anhydrides, and derivatives thereof are selected from the group consisting of maleic anhydride, maleic acid, substituted maleic anhydride, mono-ester of maleic anhydride, itaconic anhydride, itaconic acid, substituted itaconic anhydride, monoester of itaconic acid, fumaric acid, fumaric anhydride, fumaric acid, substituted fumaric anhydride, monoester of fumaric acid, crotonic acid and its derivatives, acrylic acid, and methacrylic acid.

10. The composite material of claim 1 wherein said polymeric compatibilizing agent comprises from 99.5 to 50 weight percent, of methyl methacrylate units; from 0.5 to 50 weight percent, of methacrylic acid units; and from 0 to 20 weight percent of monomer units selected from styrene and functionalized styrene.

11. The composite material of claim 1, wherein said polymeric compatibilizing agent has a weight average molecular weight of from 25,000 to 150,000.

12. The composite material of claim 1, wherein said polymeric compatibilizing agent is a random copolymer.

13. The composite material of claim 1, wherein said polymeric compatibilizing agent is a block copolymer.

14. The composite material of claim 1, wherein said polymeric compatibilizing agent is a gradient copolymer.

15. The composite material of claim 1, wherein said thermoplastic is selected from the group consisting of polyvinyl chloride, chlorinated poly vinyl chloride, high density polyethylene, low density polyethylene, polypropylene, other olefin resins, polystyrene, acrylonitile/styrene copolymers, acrylonitrile/butadiene/styrene copolymers, ethylene/vinyl acetate copolymers, polymethyl methacrylate and vinyl chloride copolymers.

16. The composite material of claim 15, wherein said thermoplastic is polyvinyl chloride or chlorinated polyvinyl chloride.

17. The composite material of claim 1, wherein said cellulosic fiber comprises a natural fiber.

18. The composite material of claim 17 wherein said cellulosic fiber is wood fiber.

19. The composite material of claim 1, wherein said cellulosic fiber comprises a pulped cellulosic fiber.

20. The composite material of claim 1, further comprising an antimicrobial additive.

21. The composite material of claim 1, comprising a powder, a pellet, or an article.

22. The composite material of claim 21, wherein said article comprises a foamed composite material.

23. The composite material of claim 21, wherein said article is formed by extrusion or injection molding.

24. A process for reducing the fusion time in the processing of a thermoplastic composition, comprising adding to said thermoplastic, prior to or during processing, a fusion control agent comprising a terpolymer comprising:
a) 0.5-20 percent by weight of monomer units selected from the group consisting of ethylenically unsaturated carboxylic acids, ethylenically unsaturated carboxylic acid anhydrides, and derivatives thereof;
b) 1 to 40 percent by weight of monomer units selected from styrene and functionalized styrene; and
c) 40 to 98.5 percent by weight of monomer units selected from the group consisting of C₁₋₈ alkyl acrylates and methacrylates, and vinyl acetate.

25. The process of claim 24 wherein said ethylenically unsaturated carboxylic acids, ethylenically unsaturated carboxylic acid anhydrides, and derivatives thereof are selected from the group consisting of maleic anhydride, maleic acid, substituted maleic anhydride, mono-ester of maleic anhydride, itaconic anhydride, itaconic acid, substituted itaconic anhydride, monoester of itaconic acid, fumaric acid, fumaric anhydride, fumaric acid, substituted fumaric anhydride, monoester of fumaric acid, crotonic acid and its derivatives, acrylic acid and methacrylic acid.

26. The process of claim 25, wherein said thermoplastic composition further comprises cellulosic fiber.

27. A composite material comprising a homogeneous distribution comprising:
a) 10-90 weight percent of one or more thermoplastic;
b) 10-90 weight percent of pulped cellulosic fibers; and
c) 0.5 to 15 weight percent of a polymeric compatibilizing agent—based on the weight of the cellulosic fiber, having a weight average molecular weight greater than 10,000, and having a hydrophilic moiety and a hydrophobic moiety.
